(19) United States
(12) Patent Application Publication
(10) Pub. No.: US 2024/0125636 A1
(43) Pub. Date: Apr. 18, 2024

(54) LASER DOPPLER VELOCIMETRY-BASED FLOW SENSOR FOR DOWNHOLE MEASUREMENTS IN OIL PIPES

(71) Applicant: CALIFORNIA INSTITUTE OF TECHNOLOGY, Pasadena, CA (US)

(72) Inventors: Mathieu FRADET, Pasadena, CA (US); Luis Phillipe C.F. TOSI, Los Angeles, CA (US); Mina RAIS-ZADEH, Pasadena, CA (US); Kristopher V SHERRILL, Pasadena, CA (US); Darius MODARRESS, Los Angeles, CA (US); Pavel SVITEK, Pasadena, CA (US); Katayoon MODARRESS RUBY, Rancho Palos Verdes, CA (US)

(21) Appl. No.: 18/546,420

(22) PCT Filed: Mar. 25, 2022
(86) PCT No.: PCT/US2022/021956

§ 371 Date: Aug. 14, 2023

Related U.S. Application Data
(60) Provisional application No. 63/168,218, filed on Mar. 30, 2021.

(51) Int. Cl. G01F 1/7086; E21B 47/01; E21B 47/113; G01F 1/74

(52) U.S. Cl. CPC G01F 1/7086; E21B 47/01; E21B 47/114; G01F 1/74

(57) ABSTRACT

Systems and methods for measuring flow velocity of a fluid mixture in a lateral section of an oil/gas/water well with a dual beam laser doppler velocimetry (LVD) based flow sensor are presented. According to one aspect, the flow velocity is measured by tracking movement of particles and/or features in the fluid mixture while traversing an interference pattern generated by the intersection of two separate coherent beams that are perpendicular to a direction of the flow. Flow velocity is derived based on a time it takes the particles to traverse consecutive fringes of the interference pattern as indicated by intensity peaks detected at the photodetector. The LDV-based flow sensor may be rotatable to measure flow velocities at different angular positions of a pipe in a lateral section of an oil well, rotation provided by rotation of an element of a mobile vessel to which the flow sensor is rigidly coupled.

### CROSS REFERENCE TO RELATED APPLICATIONS

The present application claims priority to and the benefit of co-pending U.S. provisional patent application Ser. No. 63/168,218 entitled “Laser Doppler Velocimetry for Downhole Application”, filed on Mar. 30, 2021, the disclosure of which is incorporated herein by reference in its entirety.

### TECHNICAL FIELD

The present disclosure generally relates to systems and methods for measuring fluid flow rate in fluid mixtures, such as, for example, mixtures of oil, water and gas found in lateral oil/gas wells.

### BACKGROUND

Detailed information about physical properties (e.g., reservoir inflow) in the downhole of an oil-gas producing well, is important to help optimize production and field development. Inflow data points such as oil-gas-water flow rates, pressure, and temperature, for example, are key to understanding the nature of the reservoir properties and the effect of well drilling and completion methods. Although useful, the inflow data are not often measured in real-time, or with considerable frequency (weekly or more frequently), along the lateral section of the well due to technical or cost-prohibitive challenges. Instead, surface well-head production data (total flow rates, pressure, temperature, etc.) are measured for well performance diagnostics and for reporting purposes.

Attempts to instrument the well for real time or at least weekly measurements with continuous electrical or fiber optic cables for powering sensors to measure and deliver physical properties in the downhole of a well have been tested and have not been cost effective. This is particularly true for shale and tight development wells that have, for example, long laterals and multiple perforation entry points of their casing pipe (to contact the rock formation) which then undergo high-pressure hydraulic fracturing to increase hydrocarbon inflows from oil-bearing rock formations. Such harsh activities can easily damage not only the sensors but also power and data cables in the downhole of a well.

Production-logging tools (PLTs) are used routinely within long, horizontal wells to make measurements of local pressure, temperature, composition and flow rates. PLTs, however, are provided as a service and require well intervention for data to be collected; the operational cost and complexity limiting the frequency the data can be collected within a well.

Unconventional tight rock geologic formations may require a large number of oil/gas wells (holes) drilled in close proximity to each other to effectively extract the hydrocarbon contained in a field. Horizontally-drilled wells may be used in these applications since the hydrocarbon-bearing rock formations tend to exist in stratified layers aligned perpendicular to the gravity vector.

The typical vertical section of these wells can be 1-3 km below the surface and can extend laterally (e.g., in a generally horizontal direction) for distances of, for example, 2-3 km or even more. Oil, natural gas, and water may enter the well at many locations (production intervals/zones open to perforations and fracturing) formed along a lateral distance (e.g., 2-3 km or more) of the well with local flow rates and composition (e.g. oil/water fractions) varying due to inherent geology and the accuracy with which the well intersects (e.g., at the production intervals or sections) the oil-bearing rock formations. In general, information about the performance or hydrocarbon delivery and capacity of a well, such as, for example, flow rate, pressure, and composition, can practically be measured at the surface of the well as-combined values and with little or no knowledge of individual contributions from each of the production intervals or zones. Lack of local information of the inflow details of the well, at, for example, the production intervals or zones, can be a barrier to improving the efficiency of oil-gas extraction from the overall field.

Better knowledge of local interval inflow data across each or multiple entry points (e.g. physical properties such as flow rates, pressure, temperature, etc.) at the downhole of a well (e.g., along the horizontal/lateral section of the well) may help in making better decisions about placement of subsequent perforation/completion intervals for production in a well and/or subsequent drilling of other wells in the field.

For example, an oil production field may have a variety of drilled wells, including an unconventional horizontal oil well that extracts oil from shale and tight formation through a plurality of production intervals or zones (e.g., shown as rectangles in FIG. 1). In order to develop the field, producing the hydrocarbon-bearing rock formations, a number of wells (i.e., holes) may be drilled and spaced, for example, in the order of 500 feet apart from each other. These wells are drilled and completed serially so that information may be gathered from a downhole of a first well, for example, and can aid in determining where to perforate the casing and to apply hydraulic fracturing at selected intervals of the formation in a second and following well.

### SUMMARY

Although the present systems and methods are described with reference to wells used in the oil industry, such systems and methods may equally apply to other industries, such as, for example, deep sea exploration or through-ice exploration. Furthermore, although the present systems and methods are described with reference to oil-gas-water mixtures found in oil wells, such systems and methods may equally apply to any other fluid mixtures.

According to one embodiment the present disclosure, a system for gathering information about physical properties in a lateral section of a well is presented, the system comprising: a mobile vessel configured for submersion into a fluid mixture of the lateral section of the well; and a flow sensor attached to the mobile vessel, the flow sensor comprising: a fiber-coupled light emitter and detector configured to emit a single coherent light beam in an infrared spectrum, and detect a back-scattered light received by the flow sensor; and a sensor head configured to split the single coherent light beam in two separate coherent light beams and recombine the two separate coherent light beams to form a diffraction pattern at a probe volume that is external to the flow sensor, wherein the back-scattered light is from features present in the fluid mixture that travel through the diffraction pattern formed at the probe volume during submersion of the mobile vessel.

According to a second embodiment of the present disclosure, a flow sensor is presented, comprising: a fiber-coupled light emitter and detector configured to emit a single coherent light beam at a wavelength of 835 nm+/−10 nm, and detect a back-scattered light received by the flow sensor; and a sensor head configured to split the single coherent light beam in two separate coherent light beams and recombine the two separate coherent light beams to form a diffraction pattern at a probe volume that is external to the flow sensor, wherein the back-scattered light is from features present in a fluid mixture that travel through the diffraction pattern formed at the probe volume during submersion of the flow sensor into the fluid mixture.

According to a third embodiment of the present disclosure, a method for measuring a flow velocity of a fluid mixture is presented, the method comprising: splitting an infrared coherent light beam into two separate coherent light beams; recombining the two separate coherent light beams to form a diffraction pattern at a probe volume region of the fluid mixture; detecting back-scattered light from features present in the fluid mixture that travel through the diffraction pattern formed at the probe volume, the back-scattered light including intensity peaks that correspond to crossing of the particles through fringes of the diffraction pattern; and based on the detecting, determining the flow velocity based on a travel time of the features across two consecutive fringes.

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates a cross sectional view of an example known oil production field, comprising one or more drilled wells for production of oil and/or gas in which a mobile vessel constructed in accordance with this disclosure may be disposed.

FIG. 2 shows a lateral section of a well of the oil production field shown in FIG. 1 comprising a plurality of production zones in which a mobile vessel constructed in accordance with this disclosure may be used.

FIG. 3 shows an example embodiment of a mobile vessel comprising a laser doppler velocimetry (LVD)-based flow sensor according to the present disclosure, the mobile vessel positioned in a lateral section of a well of the oil production field shown in FIG. 1.

FIG. 4 shows details of a cross sectional side view of the LDV-based flow sensor according to the present disclosure.

FIG. 5A shows a front view of the mobile vessel of FIG. 3 with the LDV-based flow sensor positioned at a first angular position.

FIG. 5B shows a front view of the vessel of FIG. 3 with the LDV-based flow sensor positioned at a second angular position.

FIG. 5C shows an exemplary flow composition surrounding the vessel shown in FIG. 5B.

FIG. 6 shows a schematic representative of a principle of operation of a dual beam laser doppler velocimetry used in the LDV-based flow sensor according to the present disclosure.

FIG. 7 shows graphs representative of crude oil absorbance as a function of wavelength for different crude oil densities.

FIG. 8A shows the mobile vessel of FIG. 3 within a casing pipe of a lateral well, the LDV-based flow sensor arranged in a nose of the mobile vessel.

FIG. 8B shows the mobile vessel of FIG. 3 within a casing pipe of a lateral well, the LDV-based flow sensor arranged in a main body of the mobile vessel.

FIG. 8C shows an example embodiment of another mobile vessel comprising the LDV-based flow sensor according to the present disclosure.

Like reference numbers and designations in the various drawings indicate like elements.

### Definitions

As used herein the term “flow velocity” of a fluid may refer to the motion of the fluid per unit of time and may be represented locally by a corresponding “fluid velocity vector”. As used herein, the term “flow rate” of a fluid may refer to a volume of the fluid flowing past a point per unit of time. Therefore, considering a cross-sectional area of a flow of fluid, such as a flow of fluid through a lateral section of an oil well, the flow rate through the cross-sectional area can be provided by the flow velocity at that area.

As used herein the term “flow meter” may refer to a system that that is calibrated to provide a precise measurement of the flow velocity based on signals sensed by a flow sensor.

As used herein the term “infrared”, “infrared light” and “infrared emission” are synonymous and may refer to an electromagnetic radiation (EMR) with wavelengths in a range from about 780 nanometers to 1 millimeter and longer than those of visible light. As used herein the term “near infrared”, “near infrared light” and “near infrared emission” are synonymous and may refer to an electromagnetic radiation (EMR) with wavelengths in a range from about 780 nanometers to 3,000 nanometers.

As used herein the term “visible”, “visible light” and “visible emission” are synonymous and may refer to an electromagnetic radiation (EMR) with wavelengths in a range from about 380 nanometers to about 780 nanometers. Electromagnetic radiation in this range of wavelengths is visible to the human eye.

### DETAILED DESCRIPTION

As set forth above, information may be gathered from a downhole of a first well, for example, and can aid in determining where to perforate the casing and to apply hydraulic fracturing at selected intervals of the formation in a second and following well. Other useful information that may be collected within a well includes, by way of non-limiting example, fluid flow rates/velocities. Certain sensors for measuring flow rates (velocity) in an oil well are based on spinners (e.g., impellers) that rotate with angular speeds as a function of incident flow rates. When considering an oil-water-gas-sand environment as provided in a lateral section of a well, spinner technology is challenged primarily for its robustness and longevity within the environment. This includes difficulties with calibration and survivability incited by moving parts of the spinner-based sensors in a downhole environment, especially when considering operation over a length of months and/or years.

Teachings according to the present disclosure, among other technical advantages, solve the prior art shortcomings by providing a laser doppler velocimetry (LDV)-based flow sensor configuration that may be considered as a “solid state” solution with the ability of measuring flow velocity profiles with greater accuracy and independently from flow composition (e.g., oil, gas or water) while operating unattended for extended periods of time. When integrated with a mobile vessel, the flow sensor according to the present teachings may measure flow velocities of a fluid mixture of the downhole under a wide range of thermodynamic conditions, including at downhole pressures greater than 5000 psi, accurately and efficiently.

According to some embodiments of the present disclosure, the LDV-based flow sensor may implement a laser doppler velocimetry technique wherein a laser is used to create a coherent beam that is split using a diffractive lens (e.g., diffraction grating) and recombined at a measurement location, also called a probe volume, through focusing lenses. Since the two split beams are coherent, an interference pattern may form at their intersection inside of the probe volume. As particles in a fluid mixture inside the downhole travel through the probe volume (e.g., interference pattern), they may reflect light emitted by the laser back to a photodetector (e.g., avalanche photodetector) inside of the LDV-based flow sensor. Such reflected light, or back-scattered/back-reflected light, may include maximum and minimum peaks of light intensity (e.g., fringes) caused by the interference pattern under a gaussian-like envelope. Since the fringe spacing is fixed and provided by the interference pattern, a distance in time between two maximum peaks of the light intensity detected may be proportional to the velocity/speed of the particles as they travel through the fringes. Measuring such distance in time may provide an indication of the velocity of the particles, and therefore of the velocity of the fluid (as particles flow at a velocity of the fluid they are immersed in).

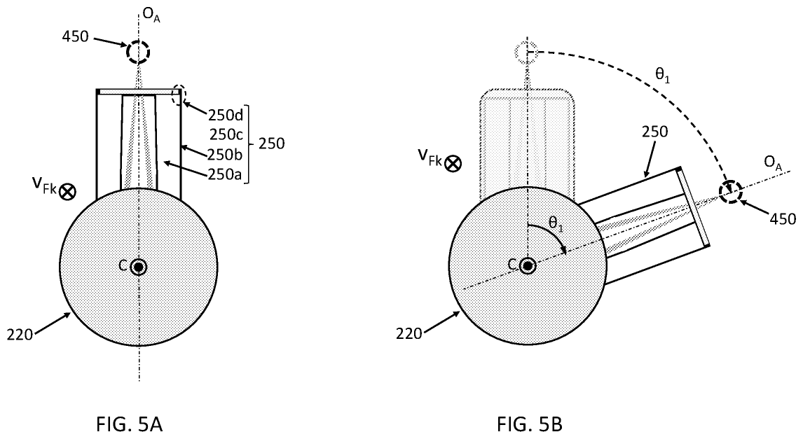

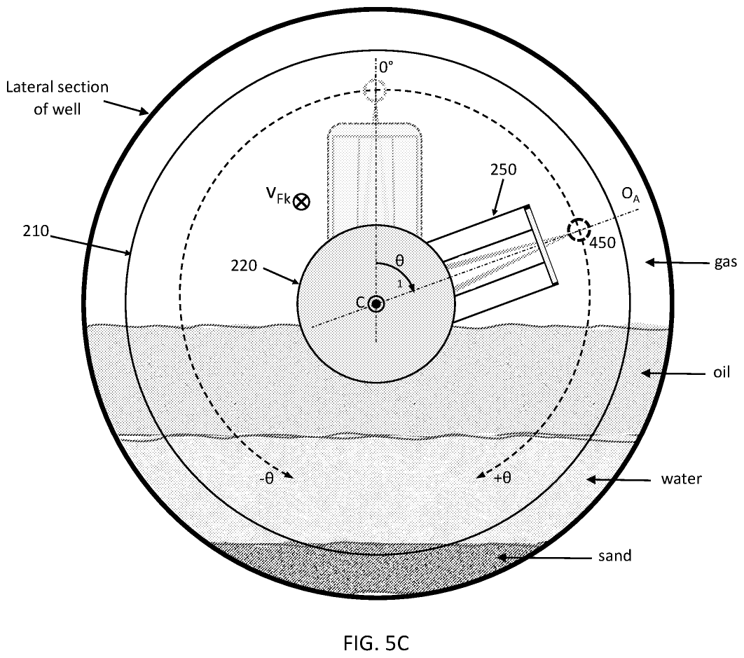

The dual LDV technique used in the LDV-based flow sensor according to the present disclosure may track the velocity of particles travelling through the probe volume (e.g., FIG. 5 later described) to determine accurately, and independently from a (flow) composition (e.g., of a fluid surrounding the flow sensor), the flow velocity. Such particles may be particles inherently present in the fluid, or other type of scatterers, including scatterers purposely injected into the fluid or other scatterers present in the fluid/composition. Scatterers can be any form of moving interface that can scatter the light within the probe volume back to the detector. Scatterers in an oil, gas and water environment may include entrained bubble in the liquid phase, entrained droplets in the gas phase, or particulates (i.e. total suspended solids or TSS). Any scatterer that may be representative of flow velocities may be used by the LDV-based flow sensor according to the present disclosure to measure/sense a representative value of the flow velocity.

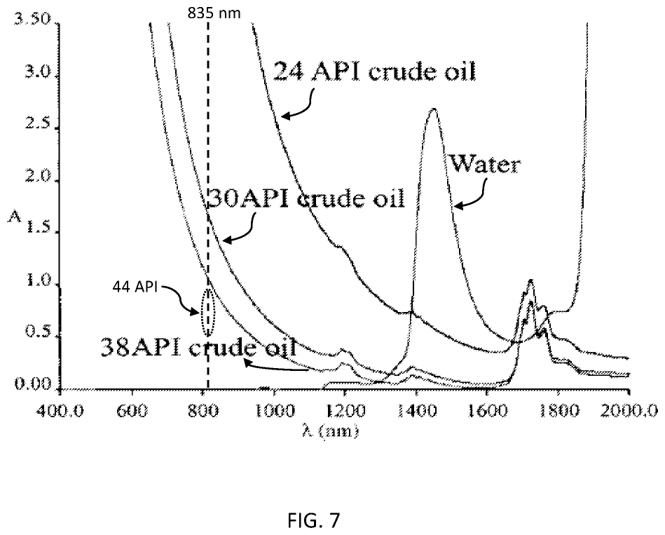

According to some embodiments of the present disclosure, the LDV-based flow sensor may use a laser emitting at a wavelength of about 835 nm (e.g., 835+/−10 nm) to allow flow measurement in oil, gas, and water environment. In particular, because such wavelength may be subjected to a lower absorbance through a range of (targeted) crude oil densities (e.g., API gravity) that may be present in the downhole, increased signal to noise performance in the detection of the back-scattered light may be obtained for a more accurate measurement of the flow velocity. For example, for a target crude oil density having an API gravity of 44, absorbance at the wavelength of about 835 nm is on the order of one or below (e.g., less than 90% of light absorbed, FIG. 7 later described), which may provide sufficient back-scattered light to the LDV-based flow sensor according to the present disclosure. According to an embodiment of the present disclosure, the laser used in the flow sensor may be a light emitting diode (LED) configured to emit a high-brightness light in the visible or the near infrared spectrum. According to a nonlimiting embodiment, such high-brightness light may include spectrally narrow light. As used herein, the expression “spectrally narrow” refers to a spectral content at full-width at half-maximum bandwidth in a wavelength range from 20 to 100 nm. According to an exemplary embodiment of the present disclosure, a near infrared super-luminescent light emitting diode (NIR SLED) may be used in the LDV-based flow sensor according to the present teachings.

The LDV-based flow sensor according to the present disclosure may be integrated as a probe assembly into a mobile vessel for immersion into the downhole of an oil pipe and in situ measurements of the flow velocity. Using a laser-based flow sensor may allow to keep the active components of the probe assembly inside of the mobile vessel and sealed from the harsh downhole environment. This eliminates the need of having any active component exposed to such harsh downhole environment, thus increasing the lifetime of such sensor.

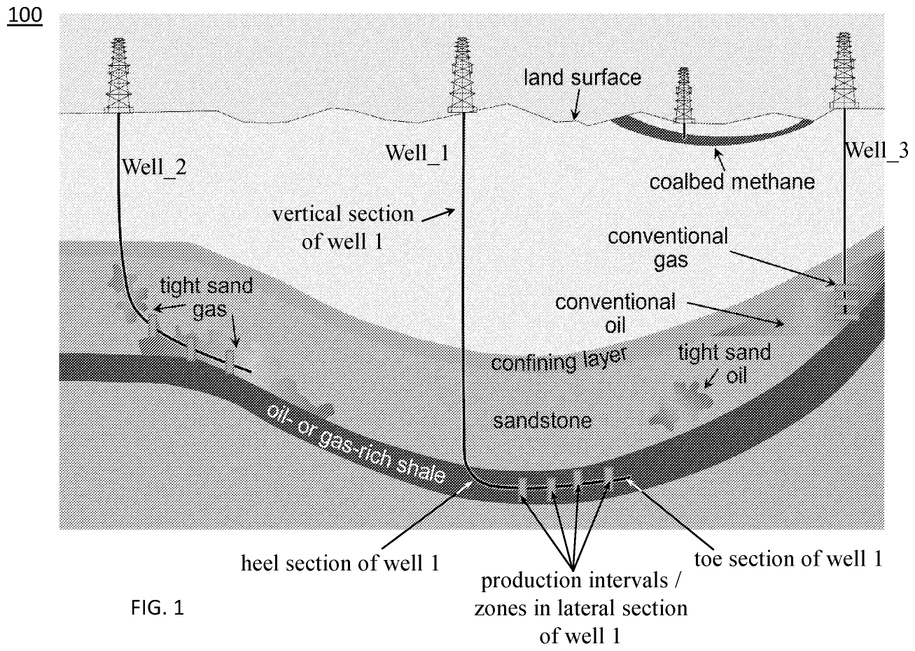

The mobile vessel described herein may be used in a number of settings, an example of which is depicted in FIG. 1, which illustrates a cross sectional view of an example oil production field (100), comprising one or more drilled wells (Well_1, Well_2, . . . ) for production and extraction of oil and/or gas from various regions of the field. In particular, as can be seen in FIG. 1, a vertical section of the Well_1 may be drilled to reach and penetrate an oil- or gas-rich shale (e.g., rock formation), and a lateral (e.g., horizontal) section of the Well_1, which, in the example case of FIG. 1 is substantially horizontal, may be drilled along the shale, starting from a heel section of the Well_1, and ending at a toe section of the Well_1. Generally, the vertical section of the Well_1 may extend 1 to 3 km below the surface and the lateral section of the Well_1 may extend for distances of, for example, 2-3 km or more.

With continued reference to FIG. 1, fluid mixtures, including (crude) oil, water, and/or natural gas mixtures, may enter the Well_1, for example, through open-hole or a casing of the Well_1, at production perforated intervals/zones that may be formed in the lateral section of the Well_1. Each of such production intervals/zones may include holes and/or openings that extract the fluid from the shale and route into the casing of the Well_1. As shown in FIG. 1, the perforated intervals/production zones may be separated by distances of, for example, about 100 meters (e.g., about 300 feet), and between each of the intervals (or stages) there are several clusters of perforations with closer spacing in order to cover a lengthy lateral and extract more hydrocarbon from shale/tight formations. Since there are many production zones, the inflow contribution for each of the intervals (or zones or clusters), such as, for example, local pressure, temperature, flow rates, and composition, may vary due to inherent geology and the accuracy with which the lateral section of the Well_1 intersects the oil-bearing rock formations at the production zones.

Collecting data at regions of the Well_1, for example close to each of the production zones, can help evaluate effectiveness of inflow contribution for each of the production zones and further help in optimizing production (e.g., by altering the perforation/completion design). The LDV-based flow sensor according to the present disclosure, integrated with a mobile vessel as described herein, may be used to measure a flow velocity of the fluid in the lateral section of the Well_1, the flow velocity inferred by velocity of particles/scatterers/features crossing the probe volume of the flow sensor. In some cases, derivation of an effective fluid velocity based on velocity of the particles crossing the probe volume may be based on a calibration routine that further takes into account any perturbation of the flow of the fluid in a region of the probe volume of the LDV-based flow sensor. For example, such calibration routine may consider flow restriction (e.g., variation of an effective cross-sectional area for the flow of the fluid) in a region of the probe volume that may result in a higher velocity of the crossing particles.

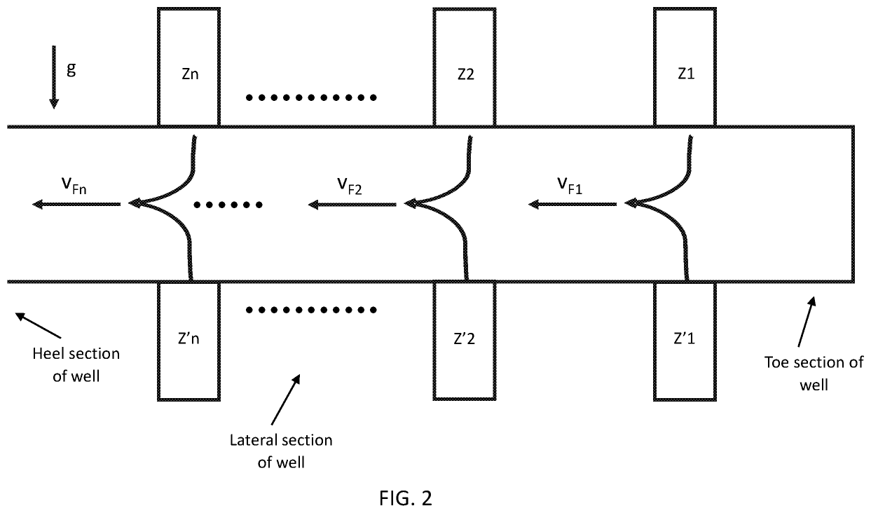

FIG. 2 shows a lateral section of a well of the oil production field shown in FIG. 1 comprising a plurality of production zones indicated as (Z1, Z′1, . . . , Zn, Z′n). Also shown in FIG. 2 are local fluid velocity vectors (V_{F1}, . . . , V_{Fn}) at vicinity of respective production zones. For example, the fluid velocity vector V_{F1}, may be considered solely based on an inflow (of fluid) contribution by the last production zone (Z1, Z′1) close to the toe section of the well. On the other hand, the fluid velocity vector V_{F2} may be considered based on a combination of the inflow contribution of the production zone (Z2, Z′2) combined with the inflow contribution of the last production zone (Z1, Z′1). In other words, a magnitude of the fluid velocity vector (V_{F1}, V_{F2}, . . . , V_{Fn}) along the lateral section of the well shown in FIG. 2 may be considered as an incremental magnitude with increments based on inflows provided by the respective production zones (Z1, Z′1, . . . , Zn, Z′n). Accordingly, a performance of each of the production zones (Z1, Z′1, . . . , Zn, Z′n) based on a corresponding inflow contribution may be assessed by measuring a difference between a magnitude of a fluid velocity vector before and after each production zone. For example, a difference between a magnitude of V_{F2} and a magnitude of V_{F1} may indicate an inflow performance of the production zone (Z2, Z′2).

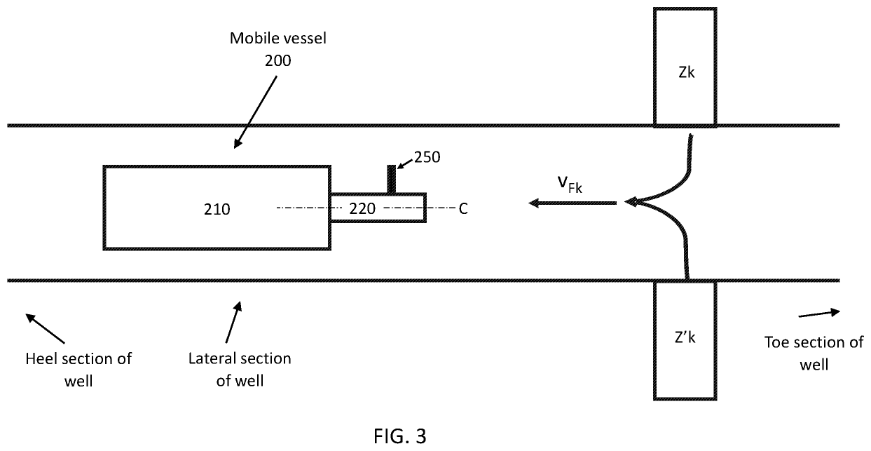

When integrated with a mobile vessel, such as a mobile robot, the LDV-based flow sensor according to the present disclosure may be used to measure the magnitude of the local fluid velocity vectors (V_{F1}, . . . , V_{Fn}). This is shown in FIG. 3, where the mobile vessel (200), including for example an element (210) and an element (220), fitted with the LDV-based flow sensor (e.g., including a probe volume guide 250) according to the present teachings is positioned downstream (e.g., towards the heel section of the well) of the production zone (Zk, Z′k) for measurement of a magnitude of the local fluid velocity vector V F k. In this case, the mobile vessel (200) may be controlled to remain stationary during the gathering/sensing of corresponding measurement data and move to a next production zone for a next measurement. In some embodiments, actual derivation of the magnitude of the local fluid velocity vector may be performed either in real-time or non-real-time based on data sensed by the LDV-based flow sensor (e.g., 250) which, in some cases, may be combined with data sensed by other sensors. It should be noted that the term “data” as used herein may relate to an ensemble of data values representative of signals gathered/sensed by one or more sensors of, for example, the LDV-based flow sensor of the present teachings. Such data may be stored on local or remote memory for immediate or future use. In the particular case of the LDV-based flow sensor of the present teachings, such data may include digitized representation of detected back-scattered light at one or more longitudinal positions and/or azimuths (e.g., angular positions) of the lateral section of the well shown in FIG. 3.

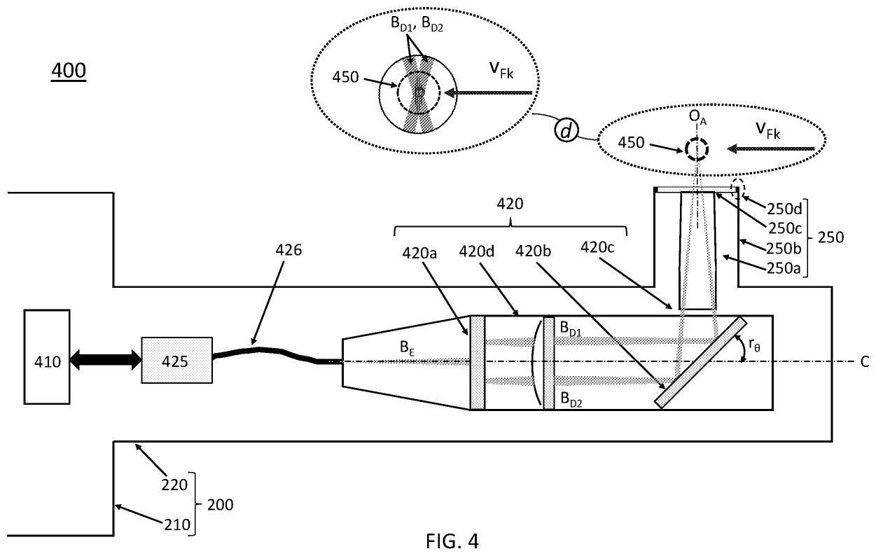

FIG. 4 shows details of a cross sectional side view (400) of the LDV-based flow sensor (250, 420, 425, 426) according to an embodiment of the present disclosure integrated with the mobile vessel (200). As shown in FIG. 4, the LDV-based flow sensor (250, 420, 425, 426) may include a fiber-coupled light emitter and detector assembly (425, 426) that includes a light emitter and detector assembly (425) coupled to a fiber optic assembly (426). The fiber optic assembly (426) may transmit (coherent beam of) light emitted from an emitter included in the assembly (425), such as a laser diode, to a LDV sensor head (420), or may transmit back-scattered light received through the LDV sensor head (420) to a photodetector (e.g., avalanche photodetector) included in the assembly (425). According to an embodiment of the present disclosure, the fiber optic assembly (426) may include: a single-mode optical fiber that may be used to transmit the light emitted from the emitter to the LDV sensor head (420); and a multi-mode optical fiber that may be used to transmit the back-scattered light received through the LDV sensor head (420) to the photodetector.

With continued reference to FIG. 4, the LDV sensor head (420) may include a diffraction grating and focusing lens assembly (420a) that may include a diffraction grating (e.g., one or more diffractive optic elements) that may split the transmitted (beam of) light, BE, into two separate (coherent) beams (B_{D1}, B_{D2}) and transmit the two separate beams to a mirror (420b) included in the LDV sensor head (420). Furthermore, the diffraction grating and focusing lens assembly (420a) may include a first focusing lens that may focus back-scattered light received at, and reflected through, the mirror (420b), onto a receiving side/surface of the fiber optic (426) that is coupled/connected to the LDV sensor head (420). According to a non-limiting embodiment of the present disclosure, the mirror (420b) may be a 45 degrees mirror, or in other words, configured to rotate an optical axis of an incident (beam of) light by an amount equal to 45 degrees. This allows for guiding of the two separate (coherent) beams (B_{D1}, B_{D2}) in a direction that is perpendicular to the flow velocity (e.g., to the local fluid velocity vector, V_{FK}, as shown in the detail (d) of FIG. 4) where particles will go through minimum and maximums interference regions created by the combined coherent beams. As shown in FIG. 4, an angle, r_{θ}, between a (reflective) surface of the mirror (420b) and a center (optical) axis, C, of the LDV sensor head (420) may be set at 45 degrees. It should be noted that, as shown in FIG. 4, the LDV sensor head (420) may have a longitudinal extension along the axis, C, which may serve as one of two main optical axes of the LDV sensor head (420), the other optical axis, denoted in FIG. 4 as O_{A}, may be orthogonal to the axis C, and according to a longitudinal direction of the probe volume guide (250). Furthermore, according to a nonlimiting embodiment of the present disclosure, as shown in FIG. 4, the axis C may be, or coincide with, a center axis of the element (220) of the mobile vessel (200).

As shown in FIG. 4, the LDV sensor head (420) may further include a second focusing lens (420c) that may focus (recombine) the two separate (coherent) beams (B_{D1}, B_{D2}), generated through the assembly (420a) and reflected through the mirror (420b), into the probe volume (450). As noted above, because the two beams (B_{D1}, B_{D2}) are coherent (e.g., from a same coherent laser light/source), their intersection within the probe volume (450) may generate an interference pattern that may be used in the LDV-based flow sensor according to the present teachings to track velocity of particles in the fluid flow. Back-scattered light from such particles may be collected by the second focusing lens (420c), rotated through the mirror (420b), and focused onto the receiving side/surface of the fiber optic (426) by the first focusing lens of the diffraction grating and focusing lens assembly (420a). It should be noted that, as shown in FIG. 4, the probe volume (450), or intersection of the two beams (B_{D1}, B_{D2}) occurs outside of the LDV-based flow sensor (250, 420, 425, 426) and at a predetermined distance away from a top surface/cap (e.g., window, 250d) of the sensor. It should be noted that the two separate beams (B_{D1}, B_{D2}) may be guided to the probe volume (450) while perpendicular to the flow direction (e.g., to the vector V_{FK}), or in other words, the two separate beams (B_{D1}, B_{D2}) passing through the flow composition may be contained within a plane that is perpendicular to the flow direction.

With further reference to FIG. 4, the LDV-based flow sensor (250, 420, 425, 426) may further include a probe volume guide (250) that protrudes the element (220) of the mobile vessel (200). An inner volume/space (250a) of the probe volume guide (250) may be defined by a base enclosure (250b) of the probe volume guide (250) that may protrude (at least during operation/measurement) outlines of the element (220) of the mobile vessel (200), and that is capped by a window (250c, e.g., light aperture). The inner volume/space (250a) may include a longitudinal extension along the optical axis, O_{A}, to provide an optical path for transmission and reception of light (e.g., through air inside of the inner volume/space 250a) that is protected from (being absorbed by) the downhole environment. Such longitudinal extension of the inner volume/space (250a), defined by a length of the base enclosure (250b) along the direction of the optical axis, O_{A}, may be adjusted according to specific design parameters of the LDV-based flow sensor, including, for example, a desired penetration length of the laser beams inside a flow composition of interest.

According to an exemplary nonlimiting embodiment of the present disclosure, the window (250c) may be fabricated from sapphire. It is presently recognized that transparency of sapphire in the visible and in the near infrared spectrum, as well as its hardness and toughness, make sapphire suitable for operation of the LDV-based flow sensor (250, 420, 425, 426) according to the present disclosure in harsh environments, including in a lateral section of an oil well (e.g., Well_1 of FIG. 1). Fixating and sealing of the window (250c) to the base enclosure (250b) may be provided through well-known in the art techniques and elements, including, for example, a combination of a clamp for holding the window (250c) against the base enclosure (250b) and an O-ring for sealing of the interface between the window (250c) and the base enclosure (250b).

With continued reference to FIG. 4, according to an embodiment of the present disclosure, sensor electronics (410) configured to control operation of active elements of the LDV-based flow sensor (250, 420, 425, 426), such as, for example, a laser diode and a photodetector included in the light emitter and detector assembly (425), and store and/or process back-scattered light received from the probe volume (450), may be included in the element (210) as shown in FIG. 4, or in the element (220), of the mobile vessel (200). Although not shown in detail, a person skilled in the art would recognize that the sensor electronics (410) may include functionalities of one or more of a microprocessor/controller (e.g., field programmable gate array FPGA), a digitizer, a memory, a filter, and other digital and/or analog electronics typically used for analog-to-digital conversion, filtering and data processing of sensed signals. Such functionalities may be partitioned into one electronic block (e.g., 410) as shown in FIG. 4, or across various electronic blocks located within the mobile vessel (200). In some embodiments, digitized data (e.g., including sensor data along with timestamps and position/location/azimuth) may be stored inside of the mobile vessel (200) and processed at a later time outside of the mobile vessel (200). In some embodiments, the sensor electronics (410) may include a power supply (e.g., a battery) block for provision of power to the various electronic blocks. Alternatively, such power supply block may be separate from the sensor electronics (410) and configured to provide power to all electrical assemblies of the mobile vessel (200).

FIG. 5A shows a front view of the vessel of FIG. 3 with the LDV-based flow sensor (250, 420, 425, 426) described above with reference to FIG. 4. In particular, FIG. 3 shows the probe volume guide (250) of the LDV-based flow sensor positioned at a first angular position about the center axis, C, of the element (220, e.g., nose) of the mobile vessel (200) shown in FIG. 3. The center axis C may be a common axis of the elements (210) and (220) of the mobile vessel (200) as shown in FIG. 3, or may be an axis that is different from (e.g., parallel to) a center axis of the element (210, e.g., main body) of the mobile vessel. According to some exemplary embodiments of the present disclosure, the elements (210) and (220) of the mobile vessel (e.g., 200 of FIG. 3) may include a tubular or cylindrical shape about the center axis C, or about a respective center axis. Also shown in FIG. 5A is a direction of the local fluid velocity vector V_{Fk} which in the example configuration of FIG. 5A is assumed (substantially) parallel to an axial direction of the lateral portion of the well, as also shown in FIG. 3.

With continued reference to FIG. 5A, according to a nonlimiting embodiment of the present disclosure, the base enclosure (250b) of the probe volume guide (250) may be symmetrical about the optical axis, O_{A}, which axis, as shown in FIG. 5A, may pass through the center axis, C, of the element (220). According to a nonlimiting embodiment of the present disclosure, a shape of the base enclosure (250b) may be cylindrical so to reduce perturbation of the fluid at vicinity of the probe volume guide (250) of the LDV-based flow sensor. Other shapes of the base enclosure (250b), including shapes about the axis of symmetry, O_{A}, may be envisioned, with a corresponding perturbation of the flow factored in a calibration routine used to determine an effective velocity of the flow.

In some cases, it may be advantageous to measure the local fluid velocity vector V_{FK} at different angular positions about the center axis C of the element (220) for derivation of an angular profile of the flow rate. It follows that according to an example embodiment of the present disclosure and as shown in FIG. 5B, the probe volume guide (250) of the LDV-based flow sensor may rotate about the center axis C of the element (220). For example, FIG. 5B shows the probe volume guide (250) at an angular position that is different by an angle θ₁ from the angular position of the probe volume guide (250) shown in FIG. 5A. Such rotation of the probe volume guide (250) about the center axis C may be considered as a rotation in the azimuth direction of the lateral portion of the well which therefore allows derivation of azimuthal profiles of the flow rate.

With continued reference to FIG. 5B, according to an example embodiment of the present disclosure, the rotation of the probe volume guide (250), and therefore of the probe volume (450), may be based on a rotation of the element (220) to which the LDV-based flow sensor (e.g., 250, 420, 425, 426 of FIG. 4) is rigidly coupled. In such configuration, the element (220), which may be referred to as a nose of the mobile vessel (200 of FIG. 3), may be a rotating part of the mobile vessel. Rotation of the nose (220) may be dependent on or independent from a rotation of the vessel itself (e.g., 210 and 220 rotating in unison). The nose (220) may rotate clockwise and/or counterclockwise to achieve a desired angular position of the probe volume guide (250) of the LDV-based sensor flow sensor. In the alternative, according to another embodiment of the present disclosure, rotation of the probe volume guide (250) may be independent from the nose (220), and based, for example on rotation of the entirety of the LDV-based flow sensor (e.g., 250, 420, 425, 426 of FIG. 4) about the center axis C.

FIG. 5C shows an exemplary flow composition surrounding the vessel shown in FIG. 5B. As shown in FIG. 5C, when the vessel (210, 220) is positioned inside of the casing of the lateral section of the oil well, it may be surrounded by a downhole composition that may include a mixture of gas, oil and water atop a bottom layer of sand/sediments. Accordingly, rotation of the probe volume guide (250) of the LDV-based sensor flow sensor about the center axis, C, may allow sensing of the flow velocity at different angular positions/azimuths where different (flow) compositions may be present. Accordingly, for any location/longitudinal position along the casing, a complete (e.g., 360°) profile of the flow velocity may be captured/sensed/measured. As previously described, the dual LDV-based flow measurement according to the disclosure may be considered independent from flow composition, and therefore, flow measurement can be performed in the presence of a single element (e.g., any one of gas, oil or water) or a mixture of such elements (e.g., any one or more of gas, oil or water). As shown in FIG. 5C, rotation of the probe volume guide (250), and therefore of the probe volume (450), about the center axis, C, may be referenced to a reference 0° angular position. The probe volume guide (250) may rotate in either positive (e.g., +θ) or negative (e.g., −θ) direction with respect to the reference 0° angular position. Although the reference 0° angular position may be based on an arbitrary angular position, in typical applications such reference may point a vector that passes through the center axis, C, and a center of the probe volume (450) in a direction opposite of the gravity vector.

With continued reference to FIG. 5C, according to an embodiment of the present disclosure, flow velocity measurements may be obtained by stepwise rotation, or continuous rotation, of the probe volume guide (250) about the center axis, C, while the mobile vessel (e.g., 210, 220) is at a stationary position along the longitudinal extension of the downhole casing. The LDV-based flow sensor according to the present disclosure may provide accurate flow velocity measurements for a continuous rotation of the probe volume guide (250) at up to 10° per minute.

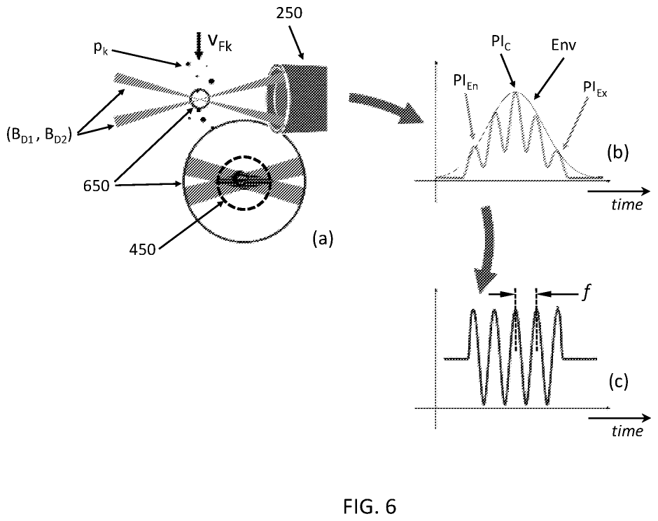

FIG. 6 shows a schematic representative of a principle of operation of the dual beam laser doppler velocimetry used in the LDV-based flow sensor according to the present disclosure. As particles (e.g., pₖ) travel along the local fluid velocity vector, V_{Fk}, that is perpendicular to the split coherent beams (B_{D1}, B_{D2}), they reach a region (650) that contains the probe volume (450), and go through the probe volume (450, showed enlarged in bottom region of FIG. 6 (a)) that contains the interference pattern generated at the intersection of the two coherent beams (B_{D1}, B_{D2}). Passing of the particles (e.g., pₖ) through the interference pattern inside of the probe volume (450) may cause light to reflect back through the probe volume guide (250) and onto the photodetector of the LDV-based flow sensor (e.g., 425 of FIG. 4).

As shown in FIG. 6(b), a peak intensity profile of the light detected/measured at the photodetector may follow a gaussian-shaped envelope, Env, that contains peak intensities (e.g., PI_{En}, PI_{C}, PI_{Ex}) corresponding to passage of the particle (e.g., pₖ) through various fringes of the interference pattern inside of the probe volume (450). Such peak intensities gradually increase as the particle (e.g., pₖ) enters one edge of the interference pattern (e.g., PI_{En}), reach a peak (e.g., PI_{C}) when the particle reaches a center of the interference pattern, and gradually decrease as the particle (e.g., pₖ) exits an opposite edge of the interference pattern (e.g., PI_{Ex}). As the fringes of the interference pattern inside of the probe volume (450) are fixed in space (e.g., distance between two fringes is fixed and predetermined by way of design of the flow sensor), a speed/velocity by which the particle (e.g., pₖ) travels through the various fringes may modulate the intensity of the reflected light according to the spacing of the fringes and corresponding maximum and minimum intensities of the fringes. In other words, as shown in FIG. 6(c), a frequency, f, of two consecutive peak intensities detected at the photodetector may correspond to a time it takes the particle (e.g., pₖ) to travel across two adjacent fringes. As a distance (e.g., d) between such two fringes is known/predetermined, the velocity of the particle may be derived (e.g., velocity=d×f). Therefore, the flow velocity, may be derived. It should be noted that FIG. 6(c) shows a filtered version of the intensity profile shown in FIG. 6(b). Although such filtering may provide some clarity in the present description, it may not be necessary for measurement of the frequency f, as such frequency may equally be measured from the intensity profile shown in FIG. 6(b).

FIG. 7 shows graphs representative of crude oil absorbance as a function of wavelength for different crude oil densities as provided by well-known in the art API gravity index, where a lower value API indicates a higher density crude oil. Accordingly, as shown in FIG. 7, absorbance at the 835 nm wavelength may be higher for a crude oil at an API value of 24 when compared to a crude oil at an API value of 30, and absorbance for the crude oil at the API value of 30 may be higher than absorbance of a crude oil at an API value of 38. As the absorbance at the 835 nm wavelength of the crude oil is about one (i.e., value of 1), extrapolation may indicate that absorbance of a crude oil at an API value of 44 (and higher) may be about one or less. Accordingly, 90% or less of light at a wavelength of 835 nm transmitted through crude oil with an API value of 44 (and higher) may be absorbed. In other words, about 10% of such light may be available for the LDV-based flow measurement according to the present disclosure. Applicant of the present disclosure have established that such absorbance may be sufficient for efficient and robust detection of flow velocity according to the present teachings.

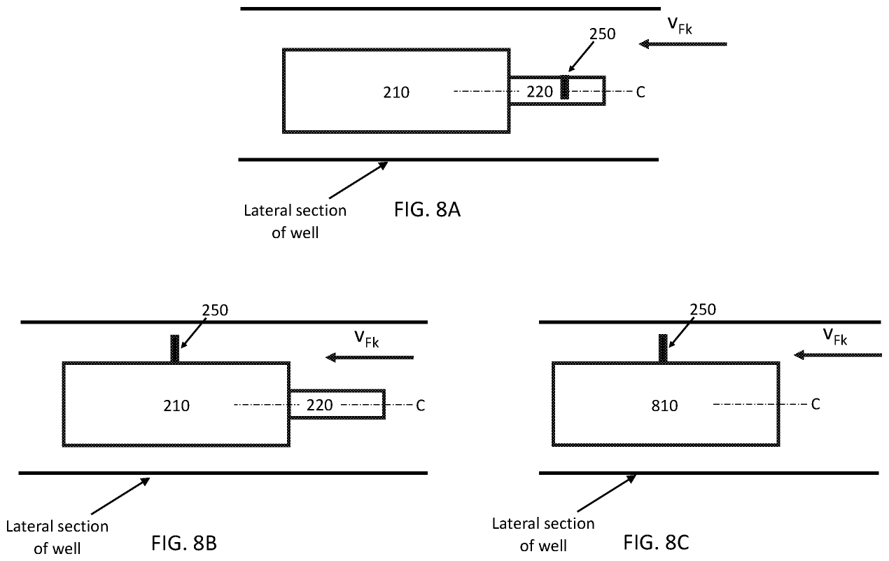

Protrusion of the LDV-based flow sensor (e.g., 250 of FIG. 3) into the flow of the fluid mixture may cause undesired perturbations in the flow that may affect measurements/sensing performed by other sensors that may be integrated into the mobile vessel. It follows that according to an embodiment of the present disclosure the probe volume guide (250) portion of the LDV-based flow sensor (e.g., 250, 420, 425, 426 of FIG. 4) may be retractable into the mobile vessel (200). This is shown in FIG. 8A, wherein the probe volume guide (250) is shown retracted into a space within the nose (220) of the mobile vessel (200). In such configuration, the LDV-based flow sensor (250) may remain in the retracted position so long flow velocity measurements are not performed. For measurement, the probe volume guide (250) may be extended outwards the nose (220) in a position as shown in FIG. 3.

It should be noted that the LDV-based flow sensor of the present teachings may be mounted on any part of the mobile vessel (200), including the main body (210) as shown in FIG. 8B. In such configuration, a different calibration routine may be performed to derive the effective fluid velocity in view of a different flow restriction imposed in a region of the field of view of the camera. Furthermore, it should be noted that the LDV-based flow sensor of the present teachings may be mounted on any mobile vessel configured for immersion in harsh environments such as, for example, a downhole of a well, including the lateral section of the well (e.g., lateral section of well_1 shown in FIG. 1). In other words, the mobile vessel may not necessarily be a mobile robot with advanced technologies. Rather, it can be a simple submersion vessel (810) as shown in FIG. 8C fitted with the LDV-based flow sensor according to the present teachings, including the probe volume guide (250).

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A system for gathering information about physical properties in a lateral section of a well, the system comprising:
a mobile vessel configured for submersion into a fluid mixture of the lateral section of the well; and
a flow sensor attached to the mobile vessel, the flow sensor comprising:
a fiber-coupled light emitter and detector configured to emit a single coherent light beam in an infrared spectrum, and detect a back-scattered light received by the flow sensor; and
a sensor head configured to split the single coherent light beam in two separate coherent light beams and recombine the two separate coherent light beams to form a diffraction pattern at a probe volume that is external to the flow sensor,
wherein the back-scattered light is from features present in the fluid mixture that travel through the diffraction pattern formed at the probe volume during submersion of the mobile vessel.

2. The system according to claim 1, wherein:
the sensor head includes a mirror that is configured to guide the two separate coherent light beams towards the probe volume in a direction that is perpendicular to a direction of the flow.

3. The system according to claim 2, wherein:
the mirror is further configured to guide the back-scattered light towards a light detector of the fiber-coupled light emitter and detector.

4. The system according to claim 2, wherein:
the mirror is at an angle of 45 degrees relative to a direction of the single coherent light beam.

5. The system according to claim 2, wherein:
the flow sensor further includes a probe volume guide that provides a sealed volume for guiding of the two separate coherent light beams towards the probe volume and for receiving of the back-scattered light from the probe volume.

6. The system according to claim 5, wherein:
the probe volume guide includes a longitudinal shape according to the direction that is perpendicular to the direction of the flow.

7. The system according to claim 5, wherein:
the probe volume guide includes a window that defines an exit plane of the probe volume guide, the exit plane perpendicular to the direction that is perpendicular to the direction of the flow.

8. The system according to claim 7, wherein:
the window comprises sapphire.

9. The system according to claim 1, wherein:
the sensor head further includes a diffraction grating that is configured to receive the single coherent light beam and split the single coherent light beam into the two separate coherent light beams.

10. The system according to claim 1, wherein:
the sensor head further includes a focusing lens that is configured to guide the two separate coherent light beams to intersect at the probe volume such as to form the diffraction pattern.

11. The system according to claim 10, wherein:
the focusing lens is further configured to collect the back-scattered light.

12. The system according to claim 1, wherein:
the fiber-coupled light emitter and detector includes a laser diode coupled to a single-mode optical fiber for emission of the single coherent light beam.

13. The system according to claim 1, wherein:
the laser diode operates at a wavelength that is equal to 835 nm+/−10 nm.

14. The system according to claim 1, wherein:
the laser diode operates at a wavelength that is equal to 835 nm.

15. The system according to claim 1, wherein:
the fiber-coupled light emitter and detector includes a photodiode coupled to a multi-mode optical fiber for detection of the back-scattered light.

16. The system according to claim 1, wherein:
the photodiode is an avalanche photodiode.

17. The system according to claim 1, wherein:
the mobile vessel comprises a first element having a substantially tubular shape about a center axis, the first element configured to rotate about the center axis, and
the flow sensor includes an enclosure and a window that in combination provide a sealed interior space for protection of the fiber-coupled light emitter and detector and of the sensor head, the enclosure and the window protruding from the first element and rigidly attached to the first element.

18. The system according to claim 17, wherein:
the enclosure comprises a cylindrical shape that is radially attached to the first element.

19. The system according to claim 18, wherein:
a direction of each of the two separate coherent light beams is perpendicular to the center axis.

20. A flow sensor, comprising:
a fiber-coupled light emitter and detector configured to emit a single coherent light beam at a wavelength of 835 nm+/−10 nm, and detect a back-scattered light received by the flow sensor; and
a sensor head configured to split the single coherent light beam in two separate coherent light beams and recombine the two separate coherent light beams to form a diffraction pattern at a probe volume that is external to the flow sensor,
wherein the back-scattered light is from features present in a fluid mixture that travel through the diffraction pattern formed at the probe volume during submersion of the flow sensor into the fluid mixture.

21. The flow sensor according to claim 20, wherein:
the flow sensor further includes a probe volume guide that provides a sealed volume for guiding of the two separate coherent light beams towards the probe volume and for receiving of the back-scattered light from the probe volume,
the probe volume guide includes a longitudinal shape according to a direction that is perpendicular to a direction of the single coherent light beam, and
the probe volume guide further includes a window that defines an exit plane of the probe volume guide, the exit plane perpendicular to a direction of the two separate coherent light beams when guided towards the probe volume.

22. A method for measuring a flow velocity of a fluid mixture, the method comprising:
splitting an infrared coherent light beam into two separate coherent light beams;
recombining the two separate coherent light beams to form a diffraction pattern at a probe volume region of the fluid mixture;
detecting back-scattered light from features present in the fluid mixture that travel through the diffraction pattern formed at the probe volume, the back-scattered light including intensity peaks that correspond to crossing of the particles through fringes of the diffraction pattern; and
based on the detecting, determining the flow velocity based on a travel time of the features across two consecutive fringes.
